(19) United States
(12) Patent Application Publication
(10) Pub. No.: US 2005/0019487 A1
(43) Pub. Date: Jan. 27, 2005

(54) Method of producing corrosion-resistant apparatus and apparatus produced thereby

(75) Inventors: Max Braun, Wedemark (DE); Carsten Brosch, Hannover (DE)

Correspondence Address: CROWELL & MORING LLP;INTELLECTUAL PROPERTY GROUP, P.O. BOX 14300, WASHINGTON, DC, 20044-4300, US

(73) Assignee: Solvay Fluor und Derivate GmbH, Hannover (DE)

(21) Appl. No.: 10/870,494

(22) Filed: Jun. 18, 2004

Related U.S. Application Data
(63) Continuation of application No. PCT/EP02/14219, filed on Dec. 13, 2002.

(30) Foreign Application Priority Data
Dec. 21, 2001 (DE) DE 101 63 171.5

(51) Int. Cl. B32B 15/00

(52) U.S. Cl. 427/230; 428/650; 428/680

(57) ABSTRACT

The production of corrosion-resistant apparatus or equipment from alloys which are resistant to chemically aggressive media, such as media which contain hydrogen fluoride or which release hydrogen fluoride, and apparatus and equipment so made. The alloys used in the invention contain aluminum and nickel or aluminum and silicon. The alloys can be used, for example, to produce devices such as reactor vessels, pipelines, agitator devices, sampling devices, etc., which can be used for carrying out fluorination reactions, especially the synthesis of fluorinated organic compounds using hydrogen fluoride and an antimony halide catalyst.

### CROSS REFERENCE TO RELATED APPLICATIONS

This application is a continuation of international patent application no. PCT/EP02/14219, filed Dec. 13, 2002, designating the United States of America and published in German as WO03/054241, the entire disclosure of which is incorporated herein by reference. Priority is claimed based on Federal Republic of Germany patent application no. DE 101 63 171.5, filed Dec. 21, 2001.

### BACKGROUND OF THE INVENTION

The present invention relates to a novel use for alloys, which contain nickel and/or silicon, as well as at least 3.5% by weight of aluminum and to apparatus produced from such alloys.

It is well known that chemical media, for example, chemical compounds (such as hydrogen fluoride, hydrofluoric acid), reaction media (such as etching solutions or reaction mixtures, which contain hydrogen fluoride or hydrofluoric acid), as well as media which can release hydrogen fluoride (for example, by hydrolysis or as a reaction product), can be very aggressive or corrosive. As stated in U.S. Pat. No. 6,124,511 (=EP 823,412), even such resistant materials, as Hastalloy^{YM}, Inconel™ and Monel™ are corroded. In this prior patent, it is recommended that a material, which contains at least 10% by weight of aluminum, be used for halogenation reactions. Preferred additional materials include iron, copper, manganese, cobalt and chromium.

The resistance of essentially pure aluminum in fluorination reactions is known already from the British patent GB 853 297.

### SUMMARY OF THE INVENTION

It is an object of the present invention to provide a method of producing equipment made of corrosion-resistant alloys which is suitable for contact with chemically aggressive media.

Pursuant to this invention, alloys are used, which contain nickel and/or silicon, as well as at least 3.5% by weight of aluminum and preferably at least 4.5% by weight of aluminum, for producing equipment which comes into contact with chemically aggressive media.

As used herein, the term “aggressive media” refers to gaseous, liquid or solid media, which are capable of corroding Hastalloy™, Inconel™ or Monel™. Preferably, in the present invention, the expression “chemically aggressive media” refers to gaseous, liquid or solid materials, which contain or are capable of releasing hydrogen fluoride, and especially to those materials, which also contain halogenated hydrocarbons in addition to hydrogen fluoride.

In the context of the present invention, the term “equipment” refers in the widest since to a part made of metal or to several mutually connected parts made of metal, which are contacted with chemically aggressive media preferably in engineering. The equipment according to the present invention may comprise, for example, apparatus or containers in which the chemically aggressive media are stored, caused to react, purified or otherwise treated, and/or objects for manipulating aggressive media. Equipment within the scope of the invention includes without limitation, for example, storage tanks, reaction vessels, analytical devices, pumps, control valves, etc. Moreover, the term “equipment” within the scope of the invention may refer to complete containers or devices, or also two parts thereof, such as pipelines, agitators or measuring rods.

The equipment may be produced completely from said alloys. However, it is also possible to produce only those parts from said alloys, which come in direct contact with the chemically aggressive media. It is also possible that only the surface of the equipment is coated with said alloys. This can be accomplished, for example, by plating methods or by metal spraying methods. Here also, of course, it is possible within the scope of the invention to appropriately coat only those parts of the equipment which come into contact with the chemically aggressive media.

In accordance with one preferred embodiment of the invention, alloys are used which comprise, or preferably consist of, aluminum and silicon. The use of alloys, which comprise, or preferably consist of, 80 to 92% by weight of aluminum and 8 to 20% by weight of silicon is particularly preferred. If other metals are contained in a less preferred embodiment, they are, for example, chromium. If the alloy used consists essentially of aluminum and silicon, it may contain incidental amounts, preferably less than 2% by weight, of other metals.

An alloy, which contains 11 to 13.5% by weight of silicon, the remainder being aluminum, has proven to be especially suitable. In the past, such an alloy has been used for welding electrodes.

In accordance with another preferred embodiment, alloys are used which comprise, or consist of, aluminum and nickel. As already stated, such alloys contain at least 3.5% by weight of aluminum and preferably at least 5% by weight of nickel. Alloys, which comprise, or consist of, 3.5% to 95% by weight of aluminum and 5% to 96.5% by weight of nickel are suitable. Preferably, the alloys contain at least 90% by weight of nickel. Alloys which contain 3.5% to 10% by weight of aluminum and 90% to 96.5% by weight of nickel, are especially suitable. Alloys, which consist of 3.5% to 10% by weight of aluminum and 90 to 96.5% by weight of nickel are particularly preferred. If other metals are present all, they are present at most in incidental amounts of less than 2% by weight.

It is a further object of the invention to provide apparatus or equipment which can be used in contact with chemically aggressive media without corroding. The surfaces of the equipment exposed to the corrosive media contains at least 3.5% by weight of aluminum, preferably at least 4.5% by weight of aluminum, and particularly preferably at least 8% by weight of aluminum. Furthermore, the equipment surface contains nickel and/or silicon or it consists of an alloy comprising at least 3.5% by weight of aluminum as well as nickel and/or silicon. The aluminum and nickel or silicon are contained in amounts corresponding to the preferred ranges given above for method of the invention. The equipment according to the invention preferably includes reactors, storage tanks, components of storage installations such as pipelines, sampling equipment, distillation equipment, agitator components or control valves. The equipment of the invention may be produced in its entirety from the alloys or it may be coated at least partly with the alloy on the surfaces which are in contact with the corrosive or aggressive media. The apparatus or equipment according to the invention is highly resistant to aggressive media.

The apparatus or equipment of the invention may be produced from the described alloys using conventional metal alloy fabrication techniques known to persons skilled in the art.

Yet another object of the invention is to provide a method for producing fluorinated compounds using hydrogen fluoride or reactants which release hydrogen fluoride. One or more pieces of equipment according to the present invention is or are used for the fluorinated compound production method of the invention. The equipment once again may be constructed entirely of these corrosion-resistant alloys or the equipment surfaces in contact with corrosive media may be coated completely with said alloys. However, equipment, which consists only partly of said alloys or which is coated only partly with said alloys can also be used. Within the scope of the present invention, the concept of “method for producing fluorinated compounds” includes also methods for purifying fluorinated compounds, which take place in the presence of hydrogen fluoride or with the release of hydrogen fluoride.

A preferred method according to the invention comprises the synthesis of fluorinated organic compounds by a halogen-fluorine exchange and/or by the addition of hydrogen fluoride using hydrogen fluoride and catalysts, preferably metal halide catalysts, especially using antimony halide or tantalum halide catalysts.

The following examples are intended to illustrate the invention in further detail without limiting its scope.

### EXAMPLE 1

### Investigation of Corrosion of Coated Samples

Various sandwich structures (see Table 1), which had been applied on a Hastalloy B 3 cylinder at a layer thickness of 250 μm, were investigated. The objective of this investigation was to find a sandwich structure, which is stable in the presence of antimony pentafluoride, hydrogen fluoride and organic compounds at 120° C. and approximately 15 bar.

Experimental Procedure:

The samples were measured and weighed. As a first step, all samples were fluorinated for 15 minutes in an FEP flask with hydrogen fluoride at room temperature and ambient pressure. All samples were fluorinated individually for 12 hours at 120° C. and about 8 bar with 50 g of hydrogen fluoride in an autoclave with a Teflon liner. Changes in mass are given in the Table.

To investigate the corrosion, samples were placed individually in an autoclave with a Teflon liner and treated with 40 g of antimony pentafluoride (0.18 moles), 32 g of hydrogen fluoride (1.6 moles) and 15 g of pentachloroethane (0.09 moles). The autoclave was heated for 48 hours to 120° in an oil bath, then cooled in ice and opened. The sample was removed from the autoclave and the corrosion solution was hydrolyzed in 10% tartaric acid. The sample piece was washed, dried, weighed and photographed.

TABLE 1
Results of the Corrosion Investigation

| | | | | Difference | Mass | | |
|---|---|---|---|---|---|---|---|
| | | | | in Mass of | Difference | | Corrosion |
| Sample | Sandwich | | Difference | Catalyst | Chlorinating | Area | Rate in |
| No. | Material | Material | in Mass | Liquid | Gas Phase | in cm² | g/cm² |
| 1 | AE 7687 | | 0.088 g | 0.070 g | | 24.06 | 0.000 |
| | (Al12Si) | | | | | | |
| 2 | Amdry 956 | Ni5Al | 0.138 g | −2.266 g | 0.043 g | 23.88 | 0.095 |
| 3 | Metco 54NS | A199% | 0.090 g | 0.035 g | 0.018 g | 23.69 | 0.000 |
| 4 | Metco 64C | Mo3C | 0.040 g | −6.466 g | — | 24.06 | 0.269 |
| 5 | Amdry 313X | Mo99.5 | 0.046 g | −5.334 g | — | 23.93 | 0.223 |

Results:

The sandwich structure materials of sample numbers 1, 2 and 3 (comparison example) are stable in this mixture of antimony pentafluoride, hydrogen fluoride and organic material at 120° C. and approximately 15 bar. samples 4 and 5 are also comparison examples and show strong corrosion.

### EXAMPLE 2

### Long-Term Corrosion Investigation of Sandwich Structure materials of samples 1 and 3

Experimental Procedure:

Sample cylinders were used which had already been exposed to the 48-hour test. To investigate the corrosion, the samples were placed individually in an autoclave with a Teflon liner and treated with 40 g of antimony pentafluoride (0.18 moles), 32 g of hydrogen fluoride (1.6 moles) and 15 g of pentachloroethane. The autoclave was heated to 120° C. in the oil bath for 233 hours. The autoclave was then cooled in ice and opened. The sample was removed from the autoclave, and the corrosion solution was hydrolyzed in 10% tartaric acid. The sample piece was washed, dried and weighed.

Result:

The sample cylinder, coated with Al2Si (sample number 1) showed no change. The coating in the region of the seam of the sample cylinder, coated with Al99% (sample number 3) was torn and there was corrosion at the rear wall. In the corrosion system investigated, the Al12Si material was stable.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. A method of producing a corrosion resistant apparatus, said method comprising producing an apparatus for containing, handling or conveying a corrosive medium with surfaces which contact said corrosive medium made from an alloy comprising at least 3.5% by weight of aluminum and at least one further element selected from the group consisting of nickel and silicon.

2. A method according to claim 1, wherein said alloy consists essentially of at least 3.5% by weight aluminum and at least one further element selected from the group consisting of nickel and silicon.

3. A method according to claim 1, wherein said corrosive medium contains or releases hydrogen fluoride.

4. A method according to claim 1, wherein said alloy comprises at least 3.5% by weight of aluminum and at least 4.5% by weight of silicon.

5. A method according to claim 4, wherein said alloy comprises at least 8% by weight of silicon.

6. A method according to claim 4, wherein said alloy comprises 80 to 92% by weight of aluminum and 8 to 20% by weight of silicon.

7. A method according to claim 4, wherein said alloy consists essentially of 80 to 92% by weight of aluminum and 8 to 20% by weight of silicon.

8. A method according to claim 1, wherein said alloy comprises at least 3.5% by weight of aluminum and at least 5% by weight of nickel.

9. A method according to claim 8, wherein said alloy comprises 3.5 to 95% by weight of aluminum and 5 to 96.5% by weight of nickel.

10. A method according to claim 9, wherein said alloy consists essentially of 3.5 to 95% by weight of aluminum and 5 to 96.5% by weight of nickel.

11. A method according to claim 9, wherein said alloy comprises 3.5 to 10% by weight of aluminum and of 90 to 96.5% by weight of nickel.

12. A method according to claim 11, wherein said alloy consists essentially of 3.5 to 10% by weight of aluminum and of 90 to 96.5% by weight of nickel.

13. A method according to claim 1, wherein said apparatus is at least partly coated with said alloy.

14. A method according to claim 1, wherein said apparatus is completely coated with said alloy.

15. A method according to claim 1, wherein said apparatus is selected from the group consisting of storage tanks, chemical reactors, pipelines, sampling devices, agitator devices, pumps and control valves.

16. A corrosion resistant apparatus for containing, handling or conveying a corrosive medium having surfaces which contact said corrosive medium, wherein said surfaces are made from or coated with an alloy comprising at least 3.5% by weight of aluminum and at least one further element selected from the group consisting of nickel and silicon.

17. An apparatus according to claim 16, wherein said apparatus is selected from the group consisting of storage tanks, reactors, pipelines, sampling devices, agitator devices, pumps, control valves, and parts thereof.

18. In a method for producing a fluorinated compound comprising reacting a compound to be fluorinated with hydrogen fluoride or a reactant which releases hydrogen fluoride, the improvement comprising carrying out said reacting in an apparatus according to claim 16.

19. The improvement of claim 18, wherein said compound to be fluorinated is an organic compound and said reacting is carried out using hydrogen fluoride and a halide-based catalyst.

20. The improvement of claim 19, wherein said catalyst is an antimony halide catalyst.
